(19) United States
(12) Patent Application Publication
(10) Pub. No.: US 2010/0013974 A1
(43) Pub. Date: Jan. 21, 2010

(54) Remote image processing for wireless communication and personal safety applications

(76) Inventor: Barrett J. Gay, Fairburn, GA (US)

Correspondence Address: BARRETT J. GAY, 7133 JOSHUA WAY, FAIRBURN, GA, 30213, US

(21) Appl. No.: 12/218,490

(22) Filed: Jul. 15, 2008

(51) Int. Cl. H04N 5/335

(52) U.S. Cl. 348/308; 348/E05.091

(57) ABSTRACT

This invention relates to wireless communication products, digital camera phones (or wireless transceiver capable of recording and transmitting digital photos); Global Positioning Satellite (GPS) applications in wireless technologies; handheld wireless safety alarms; or wireless accessories combination thereof It streamlines “Threat Phone: camera phone automation for personal safety” (Inventor: Barrett Gay; patent application Ser. No. 11/068,449; publication no. US-2006-0199609-A1; Sep. 9, 2006). Provisional patent application for “Standalone Image Capturing and Remote Digital Processing for Wireless Personal Safety” was granted to Applicant Barrett Gay, Fairburn, Ga. on Feb. 12, 2007 (USPTO-PPA No. 60/900,925).

### BACKGROUND

1. Field of Invention

Wireless communication, wireless camera/digital phones (or wireless any transceiver capable of recording and transmitting digital photos); Global Positioning Satellite (GPS) applications in wireless technologies; handheld wireless safety alarms; or wireless accessories therein.

2. Description of Prior Art

Personal safety is a fundamental need shared by everyone (“Maslow Effect”). Use of safety products or self-defense tactics present unique challenges such as courage, concentration, skills (training) and fast reaction, fundamentals not shared by everyone (“Fight, Flight or Freeze Syndrome”).

Existing camera phone functions are based on standard camera principle(s) of aim, shoot, and press buttons for result. Essentially: an added feature with no automated capabilities to instantly capture and transmit images under stressful conditions.

“Hands-free” or safety improvements for wireless communication products are predicated on motorist or road safety concerns. Hence, increased demand for wireless earpiece accessories (i.e., “Bluetooth”).

General Motor's “On-Star” combines GPS and wireless communication for emergency response service to motorists, not pedestrians. Nor does this service provide visual imagery: a critical advantage in reporting emergencies or threats.

Wireless electronic safety products for pedestrians, or anyone performing outside activity, are limited to handheld devices that emit loud sounds. These noises cannot validate a threat through audio-image capture; provide incident location; or automatically report combined data therein to proper authorities.

Safety implementations for wireless communication address motor vehicle operation.

Personal safety products require human reaction, alertness, and proficiency. No wireless transceiver or handheld personal safety instrument deters unwanted advances and automatically reports details of an incident.

3. Objects and Advantages

Limitations of camera phones and handheld electronic wireless personal safety devices attributed to 2005 invention “Threat Phone: camera phone automation for personal safety”. As a camera phone feature, Threat Phone implementation requires host unit hardware redesign and “Operating System” (OS) software integration.

Critical aspects of Threat Phone's OS programming include “audio-image-GPS” capture; “internal memory storage”; “wireless transmission” of captured data from incident scene to a “remote monitoring/analysis” location; and “unit's internal scrambling/deletion” of captured-transmitted data (to prevent privacy concerns).

Objects and Advantages of Streamlined Invention Herein

Transfer “automated/efficient image capture and wireless transmission” from a camera phone function to a standalone system.

Automatically/efficiently transmit CCD/CMOS-to-digital image processor results (standard image file format), and optional GPS data.

Image capturing instrument (camera) remains in permanent “continuous-shooting” mode.

Prevent storage of captured images to unit's hardware through automated routing (hardwired programming) of CCD/CMOS-to-digital image processor's compressed image files to antenna/transmitter.

Transmit hardware's mobile identification number, electronic serial code (ESN) or optional GPS data: in conjunction with above functions [0010] through [0013].

Deter unwanted advances or threatening behavior by including a visibly beeping, flashing, or constant illuminant object on hardware's outer casing.

Automated above functions [0010] to [0015], based on a single end user task: pressing handheld transmitter.

Automatically/efficiently transmit compressed image files from “digital image processor” (standard image file format) to a remote-receiver for storage (deferring digital-to-analog conversion).

Digital-to-analog conversion (D-A-C) technology used for image development and dissemination of digitized files stored in above function(s) [0017] (upon official legal request and/or investigative authorities therein).

User presses handheld transmitter, activating shutter speed in conjunction with the following automated functions: camera operates in “continuous shooting mode”; CCD/CMOS results are “single hardwired” to digital image processor; and digital image processor results wirelessly transmitted to a remote receiver and-server.

Efficient/automated image capture and wireless transmission from incident scene to a secure remote server.

Software Improvements/Advantages Over “Threat Phone”

Threat Phone is based on Operating System (OS) platform integration and overriding wireless communication capabilities. Its OS software allows user option of manually programming emergency data during initial setup (i.e. emergency contact, blood type and photo).

Threat Phone's OS programming automatically deletes or scrambles captured “stored” image(s).

OS/hardwired instructions for streamlined invention herein “Remote Image Processing for Wireless Communication and Personal Safety Applications” require a single task from end-users (press handheld transmitter) resulting in the following automated camera functions: shutter speed activation (in continuous shooting mode); CCD/CMOS-to-digital image processor (image file formatting and compression); and final antenna/transmitter dissemination.

### DRAWING FIGURE

FIG. 1 depicts hardwiring from “CCD/CMOS image sensor” to “digital image processor” to final “antenna/transmitter”. No digital-to-analog conversion or storage therein.

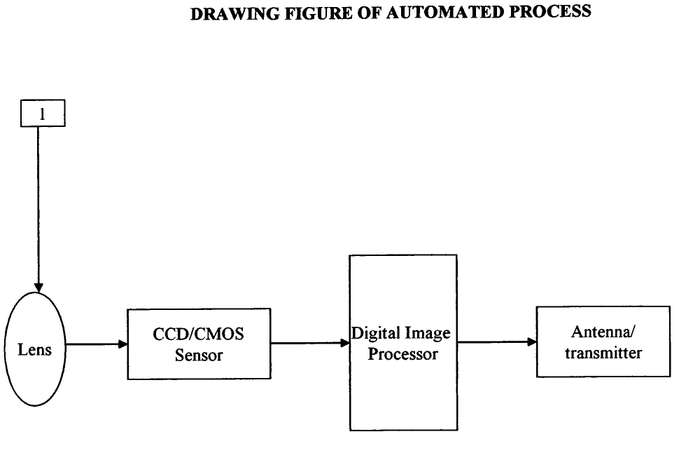

### SUMMARY

Novelties of streamlined invention herein are to transfer “instant/automated image capture and wireless transmit” from a camera phone function to a standalone unit; efficiently/automatically route CCD/CMOS-to-digital image processor results (standard image file format and compression) to antenna/transmitter.

Digital-to-analog conversion is deferred to a remote process that ensures privacy protection and cost effective operation based on “case-by-case” retrieval and handling.

### Conclusion, Ramifications, and Scope

Accordingly, the reader will see that through automated straight/hardwired routing of captured images from digital image processor (image file formatting and compression) to final antenna/transmitter, internal memory storage and privacy concerns therein can be eliminated.

Deferring digital-to-analog conversion (D-A-C), image development, storage and computerization to a remote process eliminates/reduces need for circuit D-A-C chips, memory storage chips, proprietary OS software, end user multitasking, and computer components standard for conventional wireless communication devices.

A streamlined frontend and cost effective network (ala “terminal-to-mainframe” systems).

OS or hardwired design for streamlined invention herein ensures that a panicky end-user act (pressing handheld transmitter/activator) can deter or defeat perpetrators' ability to destroy “camera stored evidence” by forcibly taking equipment from end-user.

Remote receiver-server stores image files from threat scene. Upon official legal request, stored image files therein can be queried by hardware's “subscriber identification number” (SID) or “electronic serial number” (ESN), and undergo digital-to-analog conversion for purposes of image development, analysis and dissemination.

Streamlined automated image capture and routing for invention herein is expandable to home security electronics, which are based on “intrusion detection” principles. No door monitoring technology deters or records entry-by-deception practices (i.e., “police impersonators” or “scam artists”). As a niche door security technology (i.e., “Door Guard”), lens aspects therein must exist as a view port or “peep hole” with hardware fastened on interior side of door.

What is claimed is:

1. A wireless personal safety design for automated/efficient routing of image sensor CCD/CMOS-to-digital-image-processor results (standard image file format and compression) to same unit's antenna/transmitter in conjunction with outgoing SID/ESN codes, and optional GPS data. Hence: no digital-to-analog conversion therein.

2. A wireless personal safety design for automated/efficient routing of image sensor CCD/CMOS processed raw digital files to same unit's antenna/transmitter in conjunction with outgoing SID/ESN codes, and optional GPS data. Hence: no digital-to-analog conversion therein.

3. Miniature wireless digital camera in claims 1 and 2 can exist in any hardware design or outerwear form, insofar it enables end users to instantly capture an unobstructed view of intruding threat/behavior based on a single end user task: pressing handheld transmitter (activating shutter speed in “continuous shooting” mode and “hardwired” automated functions in claims 1 and 2).

4. Miniature wireless digital camera in claims 1 and 2 can exist in any hardware design or outerwear form insofar it includes a visible beeping, flashing, or constant illuminant object signaling unit is in “ready mode” to deter/record unwanted advances or intruding threats.

5. A wireless remote computerization and image development process that receives standard formatted image files, hardware SID/ESN codes, and optional GPS data transmitted in claims 1 and 2; stores this data in same digitized format; and upon official legal request: converts it to “digital-to-analog” format for image development, analysis, and dissemination (a cost effective, streamlined, “case-by-case” result).
